(19) United States
(12) Patent Application Publication
(10) Pub. No.: US 2009/0260718 A1
(43) Pub. Date: Oct. 22, 2009

(54) STABLE WOOD PLANING ASSEMBLY OF A VENEER WOOD PLANING MACHINE

(76) Inventor: Yen-Ming WANG, Changhua City (TW)

Correspondence Address: Lu & Associates, P.C., P.O. Box 1380, HAVERTOWN, PA, 19083, US

(21) Appl. No.: 12/107,129

(22) Filed: Apr. 22, 2008

(51) Int. Cl. B27C 5/00

(52) U.S. Cl. 144/230

(57) ABSTRACT

The present invention discloses a stable wood planning assembly that can press and limit the wood veneer effectively to prevent the sharking during a planning operation. The assembly includes a pair of knife shafts having a base and a plurality of grooves disposed equidistantly from each other that the grooves of the two knife shafts are disposed alternately with each other. And the base includes a set of material pressing shoes installed axially and corresponds to a groove of the knife shaft, and the material pressing shoes has a curved surface corresponding to the groove of the knife shaft groove, at the rear end of the shoes has a spring that is used to stably press the wood veneer, and at both lateral sides of the shoes have a curvature bit guide plate which corresponds to the external diameter of the knife shaft, and a dust-collecting equipment attached.

### BACKGROUND OF THE INVENTION

1. Field of the Invention

The present invention relates to a stable wood planing assembly of a veneer wood planing machine, more particularly to a wood planning assembly with a design of maintaining the stability for a process of planing a wood veneer, and having a groove disposed between knife shafts for allowing a material pressing shoe on a lateral side to be extended deeply to the center of the knife shafts to press the wood veneer, such that the wood veneer will not be pulled and shaken by the knife tools and the planing operation can be maintained stable, so as to maintain or enhance the planing quality.

2. Description of the Related Art

In general, a wooden floor or a skirting board of a wall is usually made of a wood veneer, and such wood veneer is made by cutting a whole piece of wood into wood veneers, and then polishing and producing the wood veneers.

However, most of such wood veneers are cut by a set of parallel saws at a time during the cutting process, and the two utmost external wood veneers and the middle wood veneer have a substantial error in thickness, and it is necessary to carry out an appropriate planing operation to assure a standard specification. To meet the requirements of the planing operation of such wood veneers, manufacturers developed a specific veneer wood planing machine.

In the structural design of a traditional veneer wood planing machine, the machine includes a knife shaft, a knife tool installed on the knife shaft, and a material pressing base disposed at a material feeding end of the knife shaft, such that when a conveyor belt is used for conveying the wood veneer in a direction towards the knife shaft to carry out a surface planing operation, the material pressing base can press the wood veneer appropriately, such that the wood veneer can be passed stably through the knife shaft to complete the planing operation successfully, and the bits produced by the planing operation will be discharged to the outside according to the curvature of the material pressing base, and a dust-collecting equipment is used for collecting the bits. With the aforementioned arrangement, the veneer wood planing machine of the invention is applicable for planing a wood veneer to meet a predetermined specification.

Although the structural design of such veneer wood planing machine can use the material pressing base to press the wood veneer appropriately, yet the material pressing base affects the planing operation of the knife tool, such that the pressing point of the material pressing base cannot be extended deeply into the contact point of the knife tool with the wood veneer, or extended even to ⅓ of the knife shaft. As a result, when the knife tool is in contact with the wood veneer during the planing process, the acting stress will pull the wood veneer and shake the wood veneer, and the planing stability will be affected seriously. Such arrangement not only causes damages to the knife tool easily, but also affects the planing quality or produces defectives. Obviously, the traditional veneer wood planing machine requires improvements.

### SUMMARY OF THE INVENTION

In view of the shortcomings of the traditional veneer wood planing machine including the poor design of the material pressing base and the insufficient stability of the planing operation, the inventor of the present invention based on years of experience to conduct extensive researches and experiments, and finally developed a veneer wood planing machine in accordance with the present invention to overcome the shortcomings of the prior art.

Therefore, it is a primary objective of the present invention to provide a stable planing assembly with a structure design that allows a material pressing component to be extended deeply to the contact point of the knife tool with the wood veneer to prevent the wood veneer from being pulled and shaken by the knife tool during a planing operation, so as to maintain a stable planing operation and a good planing quality.

Another objective of the present invention is to provide a stable planing assembly with a structural design that a material pressing structure can be adjusted appropriately to cope with the thickness and specification of the wood veneer to achieve the best pressing effect and maintain a stable and smooth planing operation.

To achieve the foregoing objectives, the structural design of the invention comprises a machine platform, a pair of parallel knife shafts disposed on the machine platform, a plurality of grooves disposed equidistantly on each knife shaft, and the grooves of the two knife shafts being arranged alternately with each other, such that knives between the two knife shafts can achieve a comprehensive planing operation of the wood veneer to achieve the expected planing function, and a base is disposed on a material feeding side of each knife shaft, and the base includes a plurality of material pressing shoes disposed axially and corresponding to the grooves of the knife shaft, and each of the material pressing shoes has a curved surface corresponding to the groove of the knife shaft, and the front end of the material pressing shoe is extended beyond the center of the knife shaft, and the spring installed at a rear end of the material pressing shoe presses the material pressing shoe stably on the wood veneer, so that during a planing operation, the wood veneer will not be pulled and damaged by the knife tool, and each of the lateral sides of the material pressing shoe has a bit guide plate, and the bit guide plate has a curvature corresponding to the external diameter of the knife shaft, such that the bit produced in a planing operation can be discharged from a dust-collecting equipment to the outside by a central processing. With the stable wood planing assembly of a veneer wood planing machine of the invention, the planing quality and the stability of the wood veneer can be maintained.

To make it easier for our examiner to understand the objects, characteristics and effects of the present invention, we use preferred embodiments accompanied with related drawings for the detailed description of the present invention as follows:

### BRIEF DESCRIPTION OF THE DRAWINGS

FIG. 1 is a perspective view of an overall structure of the present invention;

FIG. 2 is an exploded view of a portion of a structure of the present invention;

FIG. 3 is an exploded view of a portion of a structure of the present invention viewing from another direction;

FIG. 4 is a top view of a structure of the present invention;

FIG. 5 is a side view of a structure of the present invention; and

FIG. 6 is a top view of a portion of a structure of the present invention.

### DETAILED DESCRIPTION OF THE PREFERRED EMBODIMENTS

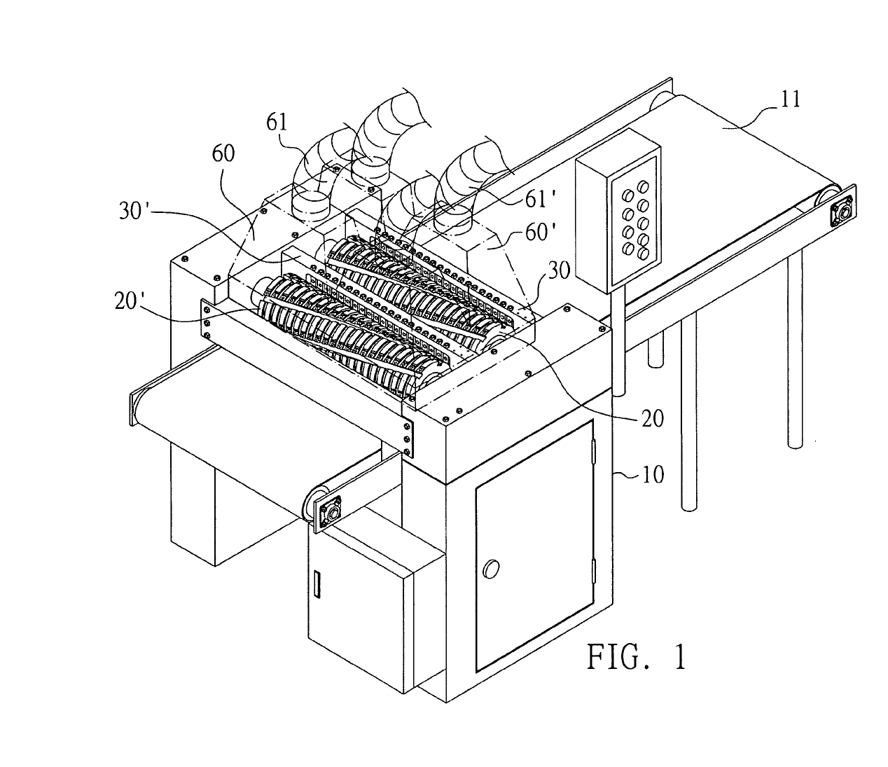

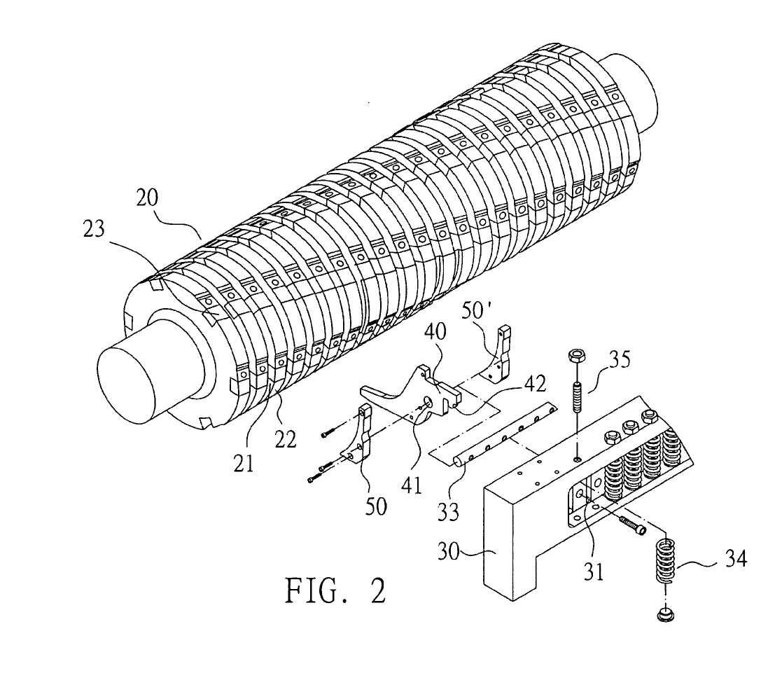

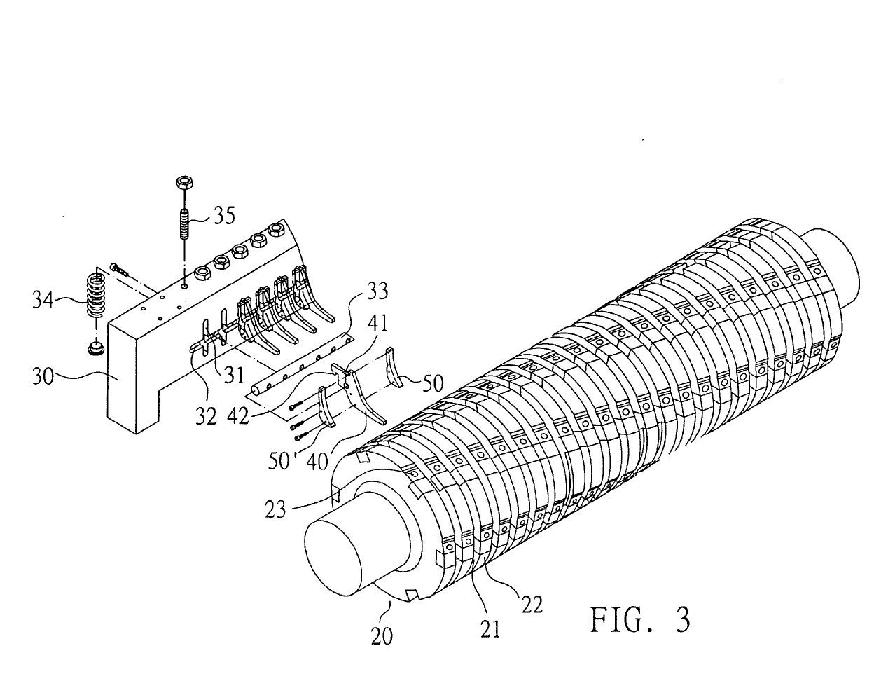

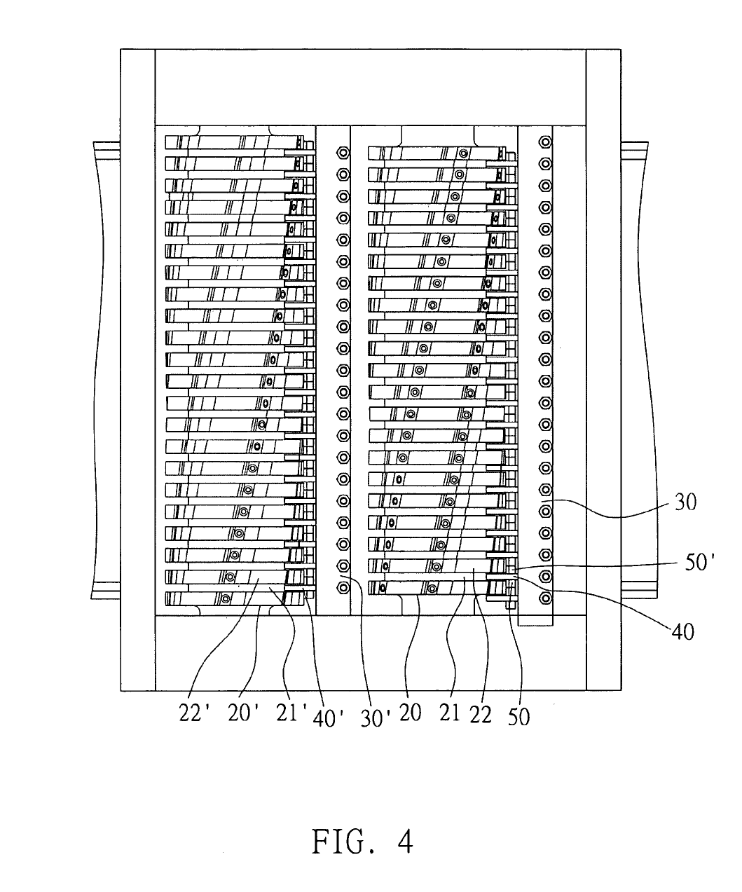

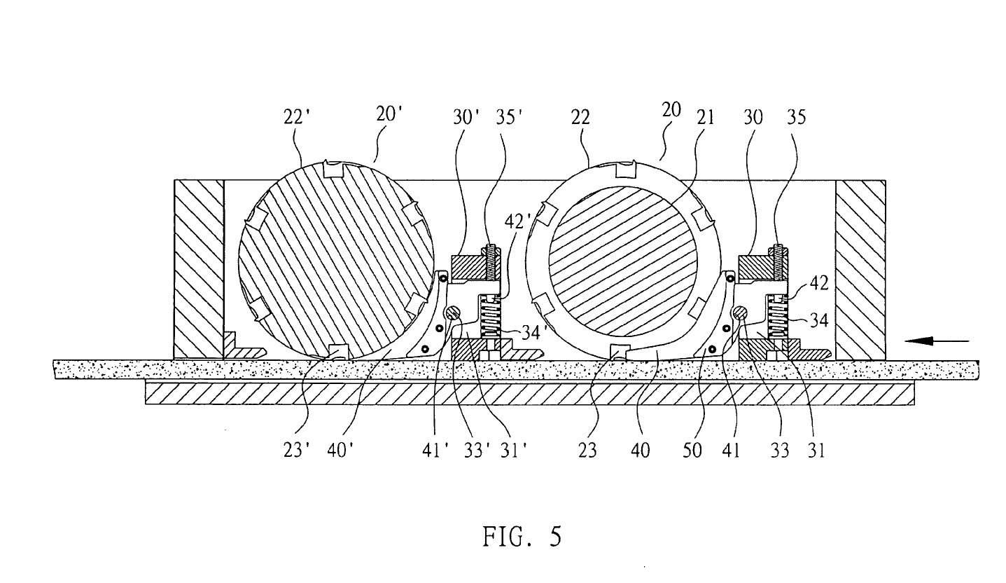

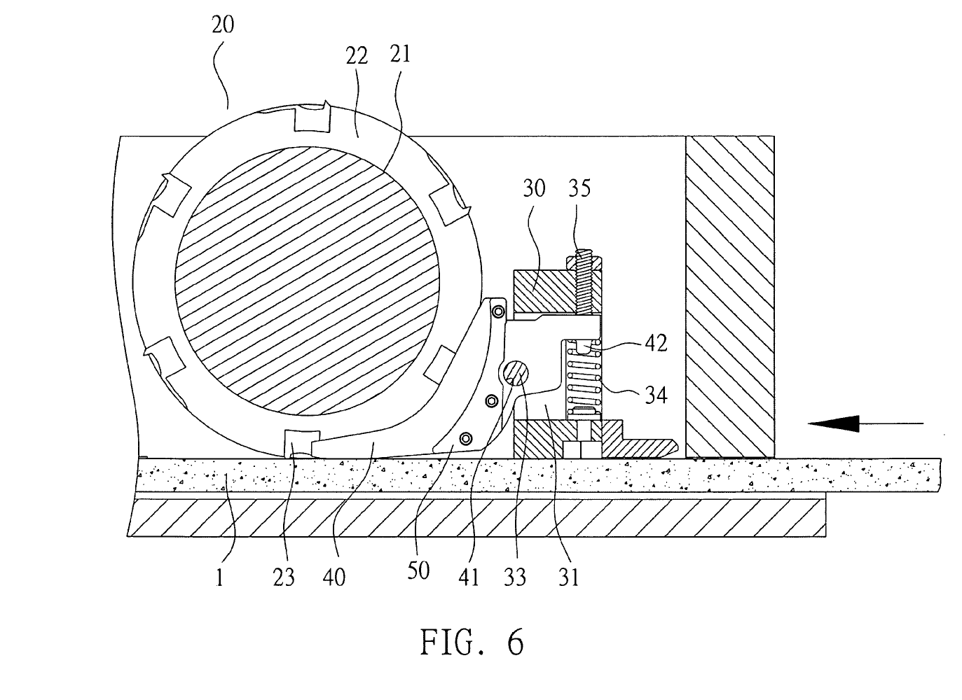

Referring to FIG. 1 for a perspective view of a structure of the invention, FIGS. 2 and 3 for exploded views of a structure and a portion of a structure of the invention respectively, and FIGS. 4 to 6 for views or a structure of the invention, a preferred embodiment of the invention comprises a machine platform 10, a pair of parallel knife shafts 20, 20′ disposed above the machine platform 10, a set of conveyor belt 11 passed below the pair of knife shafts 20, 20′ for conveying a wood veneer 1 placed on the conveyor belt 11 to the knife shafts 20, 20′, and carrying out a planing operation to a wood veneer 1 by using knife tools 23, 23′ installed on the knife shafts 20, 20′, a set of bases 30, 30′ disposed separately on a material feeding side of each knife shaft 20, 20′, a material pressing shoe 40, 40′ disposed separately at the bases 30, 30′ for pressing the wood veneer 1 appropriately to provide a stable planing operation, and a dust-collecting cover 60, 60′ covered onto a space above the knife shafts 20, 20′, and a dust-collecting tube 61, 61′ and a dust-collecting equipment (not shown in the figure) for collecting and discharging bits produced by the planing operation in a central processing, wherein:

The two knife shafts 20, 20′ have a predetermined number of grooves 21, 21′ disposed equidistantly and concavely at external peripheries of the two knife shafts 20, 20′, such that the knife tools 23, 23′ can be installed between the protruding circular portion 22, 22′ of the groove 21, 21′ and the predetermined number of knife grooves, and the knife tools 23, 23′ of each protruding circular portion 22, 22′ are arranged in a spiral shape, and the grooves 21, 21′ of the two knife shafts 20, 20′ and the protruding circular portions 22, 22′ are installed alternately with each other. Meanwhile, the width of the grooves 21, 21′ is slightly smaller than the protruding circular portion 21, 22′, and the two knife shafts 20, 20′ are used for carrying out front and rear stages of planing to the wood veneer 1 to achieve a comprehensive planing effect on a surface of the wood veneer 1.

A base 30, 30′ is disposed separately on a material feeding side of each knife shaft 20, 20′, and each base 30, 30′ includes a slot 31, 31′ disposed at the corresponding groove 21, 21′ of the knife shaft 20, 20′, and penetrated through each slot 31, 31′ by an axle hole 32, 32′, and a material pressing shoe 40, 40′ is embedded in each slot 31, 31′, and pivotally coupled by a pivot bolt 33, 33′, for providing an appropriate pivotal swinging movement of the material pressing shoes 40, 40′, and a resilient element such as a spring 34, 34′ is installed to the rear end of each material pressing shoe 40, 40′ and a bottom plate of the base 30, 30′, such that the spring 34, 34′ can be used for pushing the rear portion of the material pressing shoe 40, 40′ to maintain the material pressing shoe 40, 40′ to be pressed onto the wood veneer 1, and an adjusting bolt 35, 35′ secured to the top of the base 30, 30′ is provided for adjusting the level of pressing the top of the rear end of the material pressing shoe 40, 40′ according to a different thickness of the wood veneer 1 in a planing operation.

The material pressing shoes 40, 40′ have a curved surface at the front side and corresponding to the groove 21, 21′ of the knife shaft 20, 20′, so that the front end can be extended beyond the central line of the knife shaft 20, 20′, and the slightly rear portion of the material pressing shoe 40, 40′ includes an axle hole 41, 41′ for pivotally coupling the base 30, 30′ by a pivot bolt 33, 33′. With the pushing action provided by the spring 34, 34′ installed between the protruding pillar 42, 42′ at a lower rear edge of the material pressing shoe 40, 40′ and the bottom plate of the base 30, 30′, the material pressing shoe 40, 40′ can press the wood veneer 1 stably.

A bit guide plate 50, 50′ is installed separately on both lateral sides of each material pressing shoe 40, 40′, and the thickness of the bit guide plates 50, 50′ is only equal to ½ of the width of the protruding circular portion 22, 22′ of the knife shaft 20, 20′, and the bit guide plates 50, 50′ have a curvature corresponding to the external diameter of the protruding circular portion 22, 22′ of the knife shaft 20, 20′ for guiding the bits produced by the knife tool 23, 23′ during the planing operation.

With the foregoing structural design, the design of the groove 21, 21′ of the knife shafts 20, 20′, the knife tools 23, 23′ can plane the wood veneer 1 in a discontinuous manner. With the design of the material pressing shoe 40, 40′, the pressing point of the material pressing shoe 40, 40′ to the wood veneer 1 can be extended deeply and beyond the contact point of the knife tools 23, 23′ with the wood veneer 1. Therefore, an instant force is produced when the knife tools 23, 23′ are in contact with the planed wood veneer 1, but the wood veneer 1 is pressed by the material pressing shoe 40, 40′ and will not be pulled by the knife tool 23, 23′. In the planing operation, the wood veneer 1 will not be shaken, and thus the invention can maintain a good planing quality and prevent the knife tools 23, 23′ from being damaged.

Therefore, the structural design of the present invention and the novel design of the knife shaft for separating the knife tools by the groove allow the wood veneer to be planed discontinuously. With knife tools of the front and rear sets of knife shafts installed alternately with each other, a comprehensive planing effect of the wood veneer can be achieved. With the grooves, the wood veneer can be pressed appropriately by the material pressing shoes and extended deeply beyond the planing contact point of the knife tool of the knife shaft with the wood veneer, without interfering the planing operation of the knife tool, so as to prevent the wood veneer from being pulled and shaken by the knife tool in the planing process. The invention provides a stable planing operation of the wood veneer by the knife tools of the knife shafts during the planing process, not only preventing the knife tool from being damaged, but also enhancing the planing quality and maintaining the stability.

In summation of the description above, the stable planing assembly of a veneer wood planing machine of the invention adopts the design of dual knife shafts disposed alternately with each other, not only achieving a comprehensive planing function of the wood veneer by extending the material pressing shoe deeply to the planing contact point of the knife tool and the wood veneer to maintain a sable planing operation and a good planing quality, but also overcoming the shortcomings of the prior art. Overall speaking, the invention is a novel design in compliance with the requirements of patent application and thus is duly filed for patent application.

What is claimed is:

1. A stable wood planing assembly of a veneer wood planing machine, comprising a machine platform, a knife shaft disposed transversely at the top of the machine platform, a set of conveyor belt passed through the bottom of the knife shaft for conveying a wood veneer placed on the conveyor belt to the knife shaft, and carrying on a planing operation to the wood veneer by the knife tool installed on the knife shaft, a set of bases disposed at the knife shaft and on a corresponding material feeding side, a material pressing shoe disposed at the base for pressing the wood veneer appropriately to provide a stable planing operation, and a dust-collecting cover covered onto a space above the knife shaft, such that a dust-collecting tube and a dust-collecting equipment collect planed wood bits for a central discharge process; characterized in that:
the knife shafts disposed transversely at the top of the machine platform are a pair of parallel knife shafts, and a predetermined number of grooves are disposed equidistantly and concavely at the external peripheries of the two knife shafts, such that the knife tool can be installed between the protruding circular portion of the groove and the predetermined number of knife grooves, and the grooves of the two knife shafts and the protruding circular portion are disposed alternately with each other, and the two knife shafts are provided for carrying on front and rear stages of planning to the wood veneer to achieve a comprehensive planing effect to a surface of the wood veneer; and a base is disposed separately on a material feeding side of each knife shaft and the base includes a slot corresponding to the groove of the knife shaft for penetrating through an axle hole, and a material pressing shoe is embedded into each slot and pivotally coupled by a pivot bolt, so that the material pressing shoes has an appropriate pivotal moving effect, and a spring is installed to a rear end of each material pressing shoe and a bottom plate of the base, for pushing a rear portion of the material pressing shoe to maintain the pressing status of the material pressing shoe to the wood veneer;
the front of the material pressing shoes has a curved surface corresponding to the groove of the knife shaft, so that the front of each material pressing shoe can be extended to a planing contact point of the knife tool with the wood veneer, and a slightly rear portion of each material pressing shoe has an axle hole for pivotally coupling the base by a pivot bolt, corresponding to the pushing effect of the spring installed to the protruding pillar disposed at the lower rear end of the material pressing shoe and the bottom plate of the base, for stably pressing the wood veneer by the material pressing shoe;
a bit guide plate is installed separately on both lateral sides of each material pressing shoe, and the bit guide plates have a thickness substantially equal to ½ of the width of the protruding circular portion of the knife shaft, and the bit guide plates come with a curvature corresponding to the external diameter of the protruding circular portion of the knife shaft for guiding bits produced by the knife tool to the outside;
thereby, the groove of the knife shafts is arranged for separating the knife tools to provide a discontinuous planning mode to the wood veneer, and the front and rear knife tools of the knife shaft are installed alternately to achieve a comprehensive planing effect to the wood veneer, and the grooves are provided for pressing the material pressing shoe of the wood veneer to extend deeply beyond the planing contact point of the knife tool of the knife shaft with the wood veneer to prevent the wood veneer from being pulled and shaken by the knife tool during the planing process, such that the wood veneer can be planed stably by the knife tool of the knife shaft during the planing process, not only preventing the knife tool from being damaged, but also providing an enhanced planing quality and maintaining the stability of the planing.

2. The stable wood planing assembly of a veneer wood planing machine as recited in claim 1, wherein the width of groove of the two knife shafts is slightly smaller than the protruding circular portion, so that the two knife shafts can be used for carrying out front and rear stages of planning of the wood veneer to achieve a comprehensive planing effect on a surface of the wood veneer.

3. The stable wood planing assembly of a veneer wood planing machine as recited in claim 1, wherein the base includes an adjusting bolt installed at the top of the base corresponding to the rear of each material pressing shoe, for pressing the top of the rear of the material pressing shoe to a level to cope with a planing operation of wood veneers with different thicknesses.

4. The stable wood planing assembly of a veneer wood planing machine as recited in claim 1, wherein the front of the material pressing shoes is extended beyond a central line of the knife shaft, without interfering the knife tool of the knife shaft to provide the best pressing effect to the wood veneer.
